(19) United States
(12) Patent Application Publication
(10) Pub. No.: US 2012/0278541 A1
(43) Pub. Date: Nov. 1, 2012

(54) MEMORY SYSTEM WITH IMPROVED COMMAND RECEPTION

(76) Inventor: Ryo Yamaki, Kawasaki-shi (JP)

(21) Appl. No.: 13/426,862

(22) Filed: Mar. 22, 2012

(30) Foreign Application Priority Data
Apr. 28, 2011 (JP) 2011-100788

(51) Int. Cl. G06F 12/00

(52) U.S. Cl. 711/103; 711/E12.008

(57) ABSTRACT

According to one embodiment, a memory system includes a nonvolatile memory, a buffer, an interface unit, and a buffer control unit including a counter. The nonvolatile memory stores data. The buffer temporarily holds at least one data to be written in the nonvolatile memory. The interface unit receives a request from a host device. The counter is incremented every time a flush request is received to write, in the nonvolatile memory at once, the at least one data held in the buffer. The buffer control unit transfers the at least one data held in the buffer to the nonvolatile memory based on the count value of the counter. The interface unit can receive the next request when the buffer control unit has received the flush request.

### CROSS-REFERENCE TO RELATED APPLICATIONS

This application is based upon and claims the benefit of priority from prior Japanese Patent Application No. 2011-100788, filed Apr. 28, 2011, the entire contents of which are incorporated herein by reference.

### FIELD

Embodiments described herein relate generally to a memory system using a nonvolatile semiconductor memory, for example, an SSD (Solid-State Drive).

### BACKGROUND

A memory system serving as a storage device called an SSD using a nonvolatile semiconductor memory such as a NAND flash memory generally comprises a write buffer to efficiently write data in the NAND flash memory. The write buffer is formed from a high-speed volatile memory such as a static RAM (SRAM) to quickly respond to data write from the host. The memory system comprises a flush request (to be referred to as a flush command hereinafter) to write all data on the buffer in the NAND flash memory, for example, before power off or as needed.

During flush command processing, the memory system does not respond to a subsequent write request output from the host and causes the host to wait until the end of the write in the NAND flash memory. Hence, there is a demand for a memory system capable of discriminating data before and after a flush command and receiving another command after the flush command.

### BRIEF DESCRIPTION OF THE DRAWINGS

FIG. 1 is a block diagram showing a memory system according to the first embodiment;

FIG. 2 is a view schematically showing a write buffer control unit in FIG. 1;

FIG. 3 is a sequence chart for explaining the operation of the first embodiment;

FIG. 4 is a view schematically showing the operation of the write buffer control unit;

FIG. 5 is a view schematically showing the operation following FIG. 4;

FIG. 6 is a view schematically showing the operation following FIG. 5;

FIG. 7 is a view schematically showing the operation following FIG. 6;

FIG. 8 is a view schematically showing an operation as a comparative example of FIG. 7;

FIG. 9 is a sequence chart for explaining the operation of the second embodiment; and

FIG. 10 is a schematic block diagram showing the third embodiment.

### DETAILED DESCRIPTION

In general, according to one embodiment, a memory system includes a nonvolatile memory, a buffer, an interface unit, and a buffer control unit including a counter. The nonvolatile memory stores data. The buffer temporarily holds at least one data to be written in the nonvolatile memory. The interface unit receives a request from a host device. The counter is incremented every time a flush request is received to write, in the nonvolatile memory at once, the at least one data held in the buffer. The buffer control unit transfers the at least one data held in the buffer to the nonvolatile memory based on the count value of the counter. The interface unit can receive the next request when the buffer control unit has received the flush request.

As described above, the memory system serving as a storage device generally comprises a write buffer. This aims at improving the throughput of the write in the NAND flash memory by transferring the next write data to the buffer during data write in the NAND flash memory because the write time of the NAND flash memory is long. In addition, the data write unit of the NAND flash memory is larger than the data management unit of the host. Hence, write unit data to the NAND flash memory are completed on the buffer and then written in the NAND flash memory, thereby speeding up the write.

The write buffer is formed from a volatile memory such as a static RAM (SRAM). For this reason, it is necessary to guarantee that the data held in the buffer are not lost upon, for example, powering off the memory system. To do this, an interface such as an SATA (Serial ATA) or an SAS (Serial Attached SCSI) comprises a flush command to write all data on the buffer in the NAND flash memory. The flush command is used not only upon power-off but also to write all data on the buffer in the NAND flash memory.

During flush command processing, the memory system does not respond to a subsequent write request output from the host and causes the host to wait until the end of the write in the NAND flash memory. For this reason, during flush command processing, the host needs to wait for much longer time than during data transfer between devices (the data write time in the NAND flash memory accounts for the most part). Hence, when the flush command is issued between data writes, the data write speed is lower than the normal write speed without flush command issuance.

Assume that the interface specifications allow to connect a plurality of host devices to one memory system, like SAS. When the memory system is processing a flush command issued by a host device, and another host device is going to do write during that time, the write needs to wait for a long time. The problem of the interface capable of connecting a plurality of host devices arises because the plurality of host devices share one buffer, and data are written from the buffer to the NAND flash memory without being discriminated based on the host devices. That is, if the host devices have separate buffers, the write can be received. However, the write amount may be uneven in the host devices, or there may be a host device that is not used at all. Hence, the arrangement including a number of buffers that are not guaranteed to be used is not advisable from the viewpoint of product design.

In addition, the response delay of flush command processing is inevitable for the interface such as the SATA that connects only one host device to one storage, and no measures are taken conventionally. Causing the buffer to receive subsequent data during flush command processing corresponds to notifying the host device of completion of the flush command in spite of the incomplete flush command. For this reason, if the system is powered off before the write in the NAND flash memory is completed, the host device loses the data although the flush command should have been completed.

To prevent this, the embodiment enables to discriminate data before and after a flush command and receive a command from a host device even during flush command processing.

The embodiment will now be described with reference to the accompanying drawings.

### First Embodiment

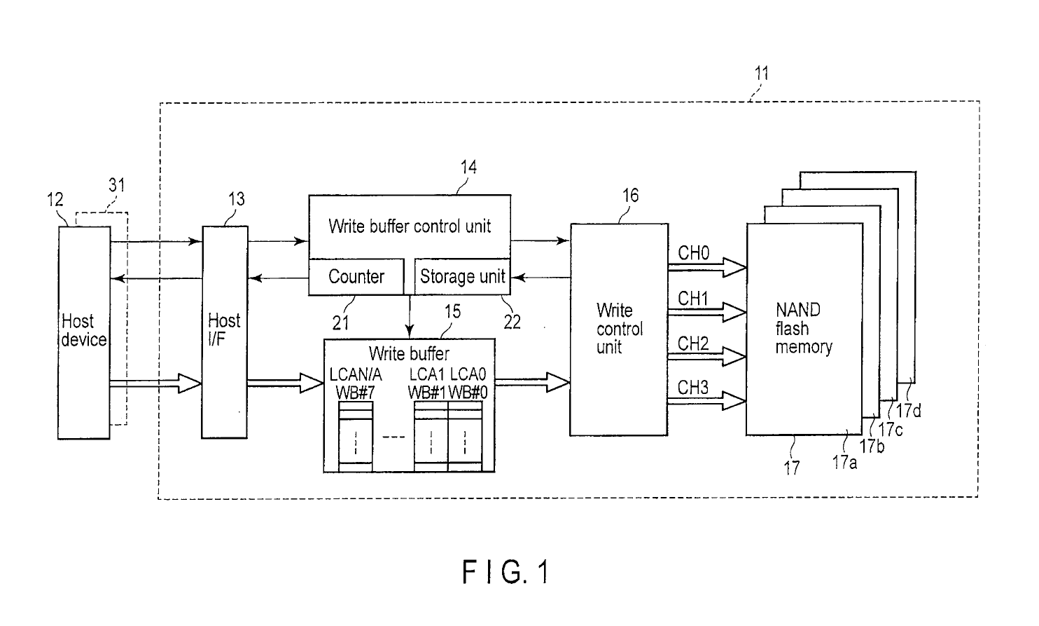

FIG. 1 schematically shows an SSD that is a memory system according to the first embodiment. FIG. 1 illustrates only a write processing system according to the first embodiment but not a read system.

Referring to FIG. 1, an SSD 11 is connected to a host device 12. The host device 12 is, for example, a personal computer or a server. The SSD 11 includes a host interface (I/F) 13, a write buffer control unit 14, a write buffer 15, a write control unit 16, and a NAND flash memory 17.

The host interface 13 performs interface processing to the host device 12. More specifically, the host interface 13 detects the free space state of the write buffer 15 and the like and controls whether to receive a write command from the host device 12. The write command from the host device 12 includes a logical address, a data, a data length, and the like.

The host interface 13 supplies the write command received from the host device 12 to the write buffer control unit 14 and also transfers the data to be written to the NAND flash memory 17.

The write buffer control unit 14 manages the data written in the write buffer 15 based on the logical address. The write buffer control unit 14 includes a counter 21 and a storage unit 22 to be described later in addition to an address translation circuit (not shown). The address translation circuit translates the logical address added to the command supplied from the host interface 13 into the physical address of the NAND flash memory 17.

In the SSD system, the unit to translate logical addresses to physical addresses will be referred to as a cluster. The cluster is a minimum unit for data management in the SSD system, and a translation unit of a logical address and a physical address. One cluster includes a plurality of sectors having continuous logical addresses. A sector is the unit to assign a logical address to data. For example, a different logical address is assigned to each 512-byte data. The number of sectors included in one cluster and the size of the translation table for translating a logical address into a physical address have a tradeoff relationship.

The write buffer control unit 14 supplies the translated physical address to the write control unit 16 and supplies the write data held in the write buffer 15 to the write control unit 16.

The counter 21 increments the count value every time the host device 12 issues a flush command. The count value of the counter 21 is held in the storage unit 22 as the management information of the data received by the write buffer 15. The storage unit 22 holds the count value of the counter 21 in cluster unit, in correspondence with continuous logical addresses WB#0 to WB#7 of the write buffer 15. That is, the storage unit 22 stores a logical address of the data stored in the write buffer 15 in corresponding to an address of the write buffer 15. The count value of the counter 12 corresponds to the logical address of the data. Referring to FIG. 1, LCA0, LCA1, . . . , LCAN/A represent logical cluster addresses.

If the counter 21 has a width of one bit, data before and after one flush command can be discriminated. If the counter 21 has N bits, the flush command before which the data in the write buffer 15 has been output can be discriminated for 2^{N}−1 commands at maximum. Based on the count value held in the storage unit 22, the write buffer control unit 14 can thus discriminate the flush command before which the data in the write buffer 15 has been output.

The write buffer 15 is formed from, for example, an SRAM capable of high-speed operation. However, the write buffer 15 is not limited to the SRAM and may be formed from another volatile memory such as a dynamic RAM (DRAM).

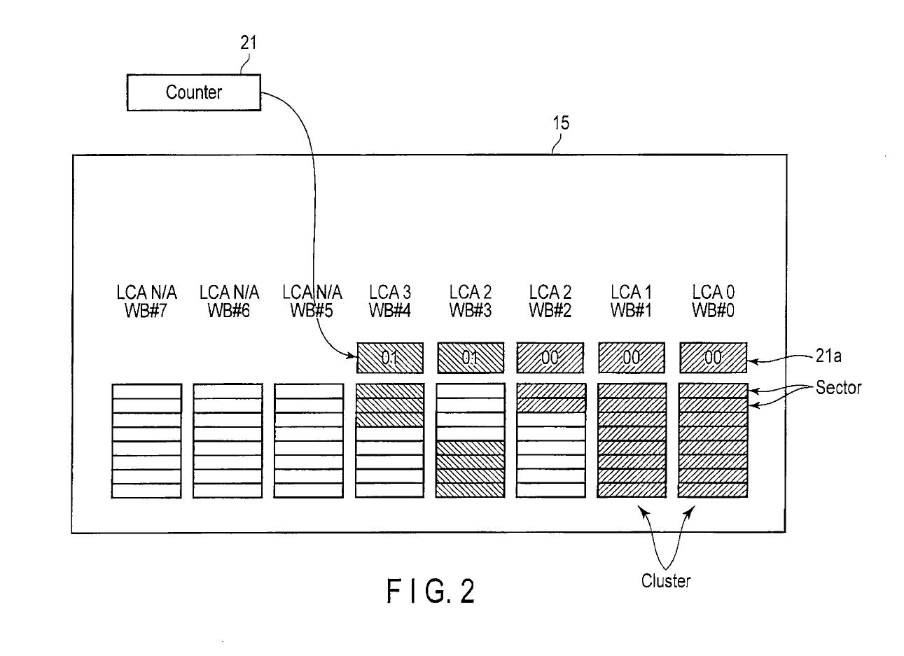

FIG. 2 schematically shows the relationship between the write buffer 15 and the count value of the counter 21. As shown in FIG. 2, the write buffer 15 has the addresses WB#0 to WB#7 set on the cluster basis.

The storage unit 22 of the write buffer control unit 14 manages a value 21a of the counter 21 in correspondence with the addresses WB#0 to WB#7 of the write buffer 15 and the logical cluster addresses LCA0, LCA1, . . . , LCAN/A.

When each sector of a cluster holds data, the write buffer 15 transfers the cluster data to the write control unit 16. The write control unit 16 writes the data in each page of the NAND flash memory 17 based on the above-described write command and physical addresses.

The NAND flash memory 17 has a plurality of bank groups 17a, 17b, 17c, and 17d capable of, for example, performing parallel operations. The bank groups 17a, 17b, 17c, and 17d are connected to the write control unit 16 via channels CH0, CH1, CH2, and CH3. Each of the bank groups 17a, 17b, 17c, and 17d includes, for example, four banks (not shown) capable of bank interleave.

In the first embodiment, even upon receiving a write command following a flush command during flush command processing, the write buffer control unit 14 can discriminate the data before and after the flush command by referring to the count value held as management information. For this reason, the write buffer control unit 14 can present only data having the attribute before flush command reception to the write control unit 16. The write control unit 16 can read out the presented data from the write buffer 15 and write it in the NAND flash memory 17.

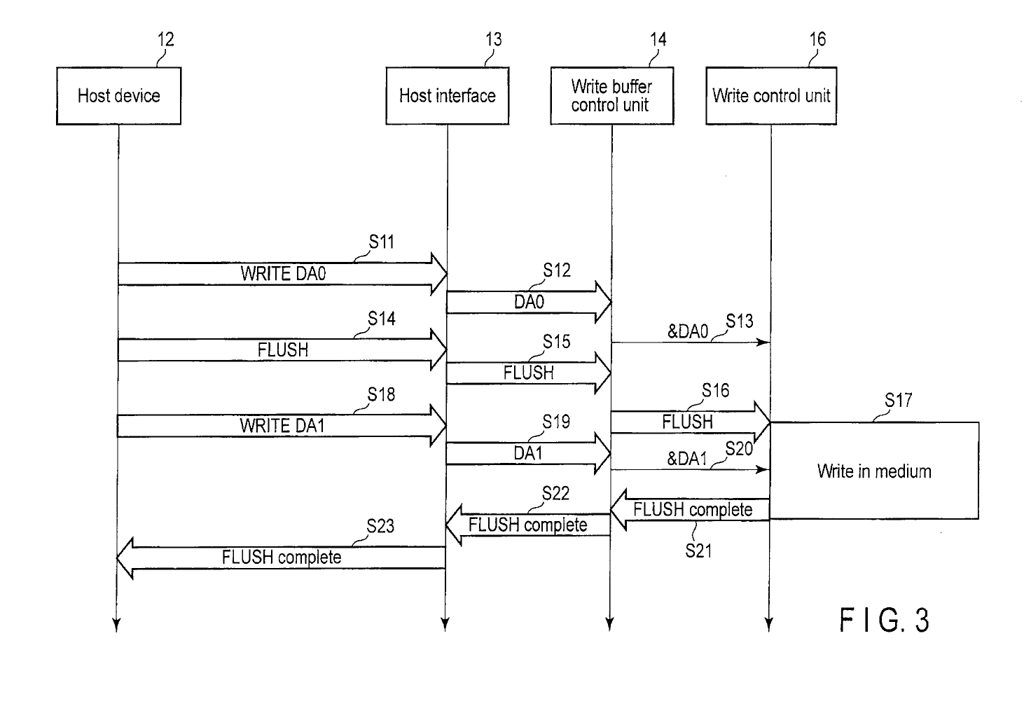

The operation of the above-described arrangement will be described with reference to FIGS. 3, 4, 5, 6, 7, and 8.

FIG. 3 shows an example of the write sequence of the first embodiment.

When the host device 12 issues, for example, a general write command “WRITE” (S11), the host interface 13 detects the free space state of the write buffer 15 and the like and controls whether to receive the write command from the host device 12. Upon receiving the write command from the host device 12, the host interface 13 supplies the write command and the logical address to the write buffer control unit 14 (S12) and transfers data supplied from the host device 12 to the write buffer 15.

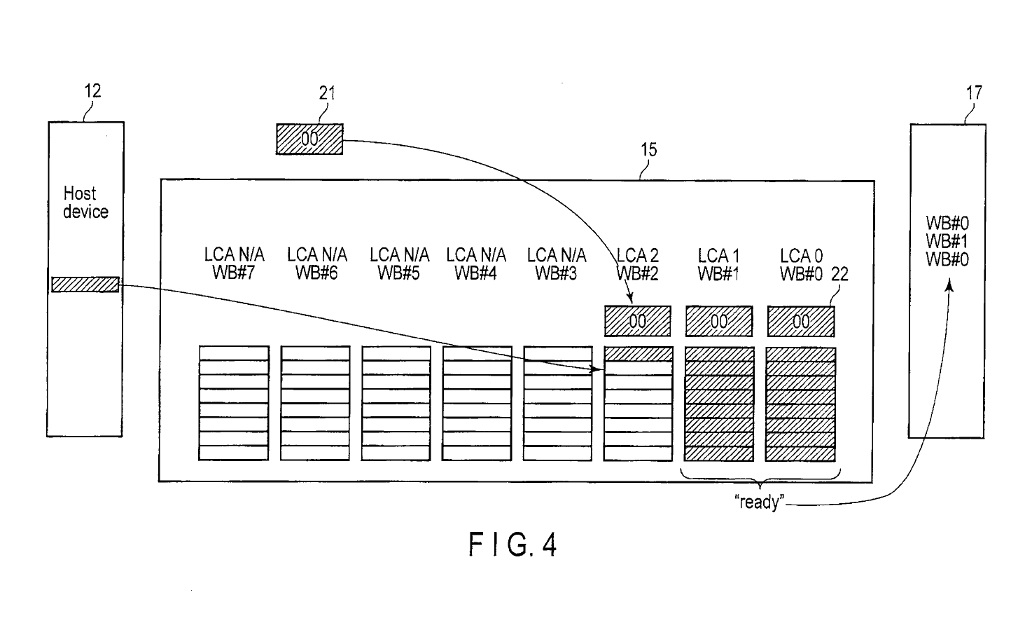

As shown in FIG. 4, upon receiving the data from the host interface 13, the write buffer control unit 14 holds the value of the counter 21 in the storage unit 22 as data management information. FIG. 4 illustrates a state in which a count value “00” is held in correspondence with the addresses WB#0, WB#1, and WB#2 and the logical cluster addresses LCA0, LCA1, and LCA2.

The write unit of the NAND flash memory is called a page that generally includes a plurality of clusters. When the amount of valid data held in the write buffer 15 reaches the page size, the write buffer control unit 14 supplies the write command to the write control unit 16 (S13). Upon receiving the write command, the write control unit 16 reads out the data from the write buffer 15 and writes it in the NAND flash memory 17.

When the write in the NAND flash memory 17 is completed, the write buffer 15 can be reused to receive new write data from the host device 12.

On the other hand, when the host device 12 issues a flush command (S14), the host interface 13 transfers the flush command to the write buffer control unit 14 (S15).

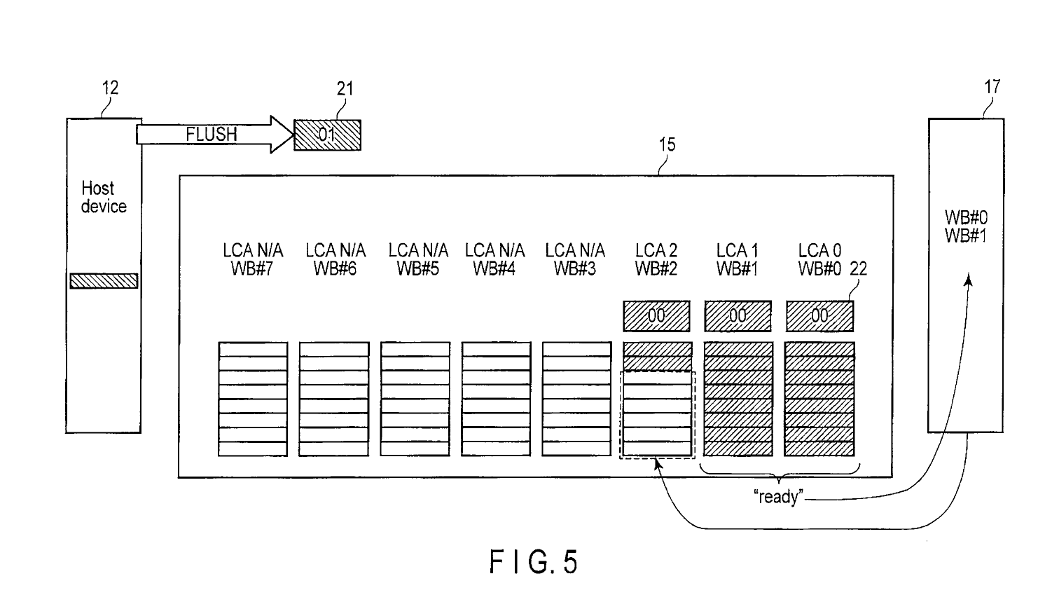

FIG. 5 shows a case in which, for example, the amount of data held in the write buffer 15 based on the write command reaches the page size, and a flush command is issued before the data is written in the NAND flash memory 17.

As shown in FIG. 5, upon receiving a flush command “FLUSH”, the write buffer control unit 14 increments the value of the counter 21 from “00” to “01”. The write buffer control unit 14 prepares to write, in the NAND flash memory 17, all data associated with the value of the counter 21 before flush command reception in the write buffer 15.

More specifically, if there is data whose size is smaller than the cluster size, as indicated by the broken line for the address WB#2 and the logical column address LCA2 in FIG. 5, for example, old data is read out from the NAND flash memory 17 and written in the free space of the cluster of the write buffer 15. Alternatively, dummy data representing an unwritten state is generated and written in the free space of the cluster. Data having the cluster size is thus generated.

When preparation for the write is completed, the write buffer control unit 14 presents only data having the attribute before flush command reception to the write control unit 16 and instructs the write control unit 16 to write the data in the NAND flash memory 17 (S16).

Even if the amount of the data having the attribute before flush command reception is smaller than the page size, the write control unit 16 reads out the data having the attribute before flush command reception from the write buffer 15 and writes it in the NAND flash memory 17 (S17).

When the host device 12 issues the next command and supplies it to the host interface 13 during the write in the NAND flash memory 17 (S18), the write buffer 15 and the write buffer control unit 14 can receive and process the next data.

Even when the host interface 13 transfers the subsequent data to the write buffer 15 during flush command processing by the write buffer control unit 14, the write buffer control unit 14 and the write buffer 15 continuously execute the above-described processing.

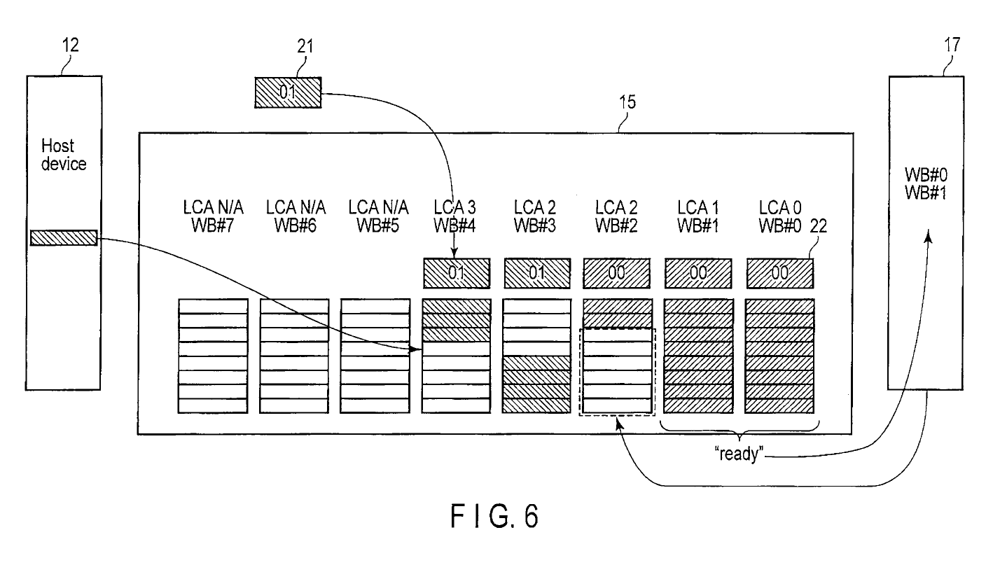

That is, when the write buffer 15 receives data from the host interface 13, the incremented value of the counter 21 is held in the storage unit 22 as the management information of the received data, as shown in FIG. 6. In the example shown in FIG. 6, a count value “01” of the counter 21 is held in the storage unit 22 in correspondence with the addresses WB#3 and WB#4 and the logical cluster addresses LCA2 and LCA3.

The host interface 13 can transfer the next data to the write buffer 15 at the timing the write buffer control unit 14 has received the flush command. Hence, the host interface 13 can receive the write command after the flush command from the host device 12. The operation of processing the received write command (S19 and S20) is the same as in steps S12 and S13.

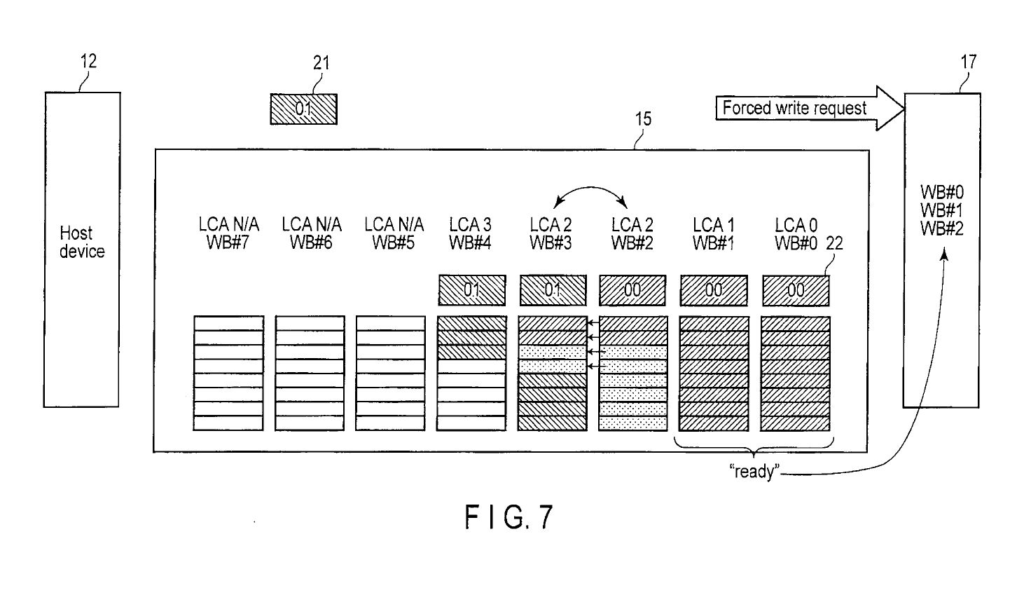

When the data corresponding to the write command before the flush command becomes ready for write during processing of the write command following the flush command, as shown in FIG. 7, the data of the addresses WB#0, WB#1, and WB#2 corresponding to the count value “00” are written in the NAND flash memory 17.

When the entry of the count value “00” is ready for the write, the data entry of the address WB#2 and the data entry of the address WB#3 can be merged because they have the same logical cluster address LCA2. Merging the data entries allows to reduce the storage area of the NAND flash memory 17.

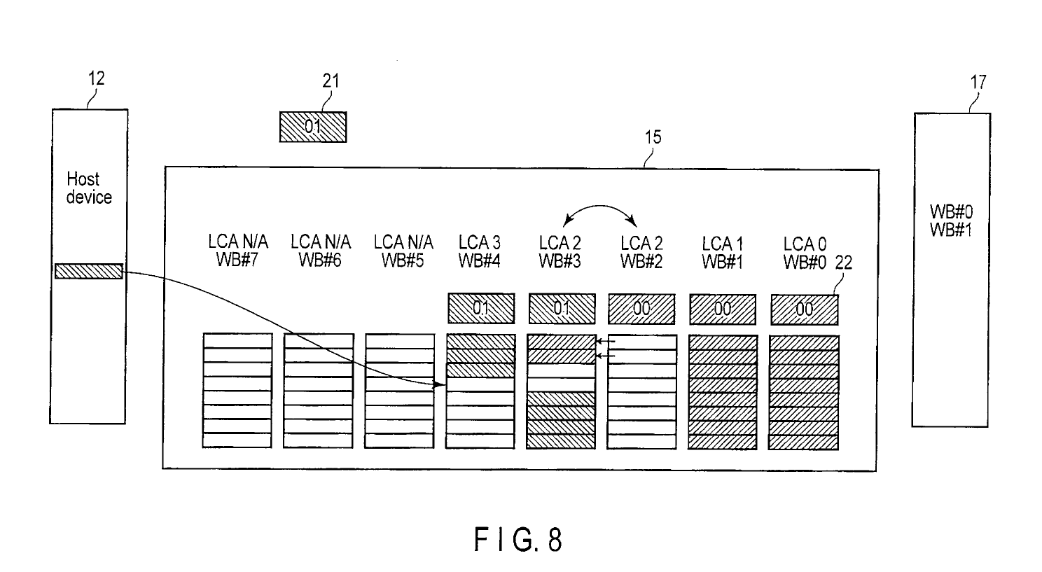

If the data of the address WB#2 is merged with the data of the address WB#3 having the same logical cluster address LCA2 before the data of the address WB#2 corresponding to the count value “00” is ready for the write, as shown in FIG. 8, the data of the address WB#2 remains in the write buffer 15 without being written in the NAND flash memory 17.

That is, data before and after the flush command must not be merged before preparation for the write in the NAND flash memory 17 is made. The data entry after the flush command must not be merged with that before the flush command. In this embodiment, the data before and after the flush command can be discriminated by the value of the counter 21. It is therefore possible to reliably merge the data entry before the flush command with the data entry after the flush command, which has the same logical cluster address, after preparation for the write has been made.

When all data to be flushed in the write buffer 15 are written in the NAND flash memory 17 in correspondence with the flush command, the write control unit 16 outputs a flush processing completion notification and supplies it to the write buffer control unit 14 (S21). The completion notification is supplied to the host device 12 via the host interface 13 (S22 and S23).

Assume that the interface specifications allow to receive a new command from the host only after the flush command processing completion notification has been returned to the host. At the timing the write buffer 15 has received the flush command, the host interface 13 returns the flush processing completion notification to the host device 12 and receives a new write command from the host device 12. Even with such interface specifications, the flush command processing can be done as in the above-described first embodiment.

According to the first embodiment, the write buffer control unit 14 includes the counter 21 whose value is incremented every time a flush command is received. The value of the counter 21 is held in correspondence with the address of data held in the write buffer 15. For this reason, data before and after the flush command can be discriminated based on the value of the counter held in correspondence with the address. Since the next write command from the host device 12 can be received before the time-consuming flush command processing is completed, the data transfer speed in the normal write can be maintained.

The data entry having the same logical cluster address is merged in the write buffer 15 and then written in the NAND flash memory 17. This allows to reduce the storage area of the NAND flash memory 17. However, when the data entry before the flush command is merged with the data entry after the flush command, which has the same logical cluster address as that of the data entry before the flush command before preparation for the write is completed, entries before the flush command may actually remain in the write buffer 15 without being written in the NAND flash memory 17 even when all the entries are presented to the write control unit 16. To prevent this, when merging the data entries, the data needs to be copied to a new entry after the flush command. At this time, since the data before and after the flush command can be discriminated based on the value of the counter held in the storage unit 22, the data can reliably be merged.

### Second Embodiment

The second embodiment will be described next. In the first embodiment, one host device 12 is connected to the host interface 13. In the second embodiment, however, a case will be explained in which a plurality of host devices are connected to a host interface 13.

That is, host devices 12 and 31 are connected to the host interface 13, as indicated by the broken line in FIG. 1. Since the system includes one write buffer 15 and one write buffer control unit 14, the host interface 13 determines which one of the two host devices 12 and 31 has supplied a command for data. The write buffer control unit 14 does not discriminate data from the host devices 12 and 31. The write buffer control unit 14 also manages data written in the write buffer 15 using a counter 21 and a storage unit 22, as in the first embodiment.

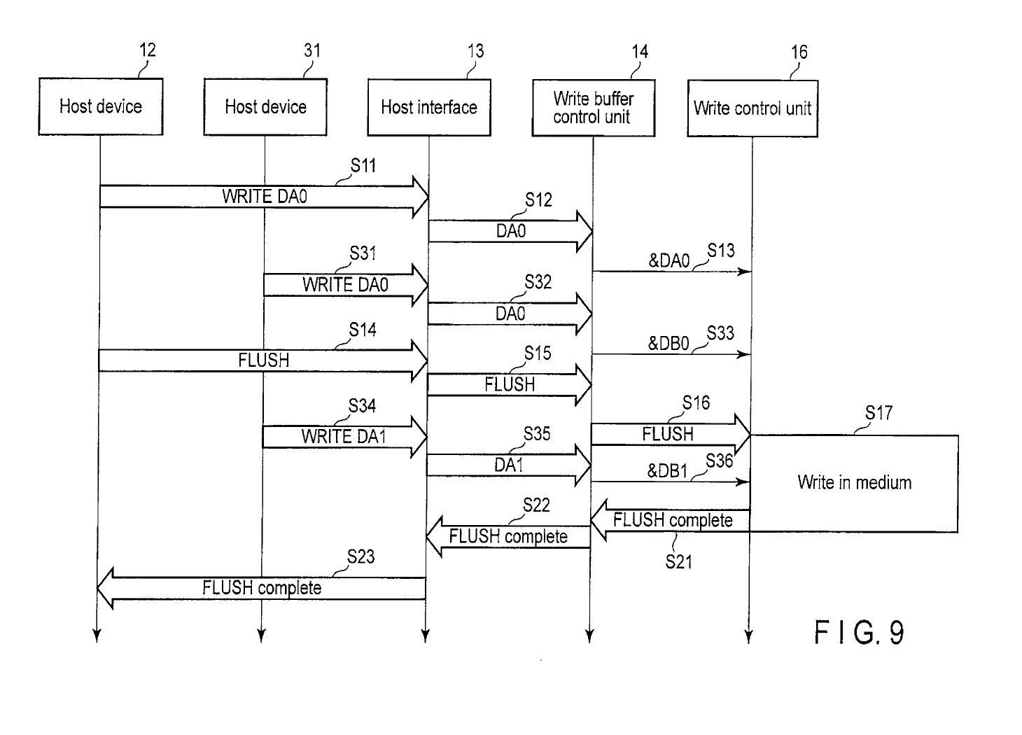

The write operation of the above-described arrangement will be described with reference to FIG. 9. Note that the same step numbers as in FIG. 3 denote the same parts in FIG. 9.

The host interface 13 receives write commands issued by the host devices 12 and 31 (S11 and S31). Data are transferred to the write buffer 15 on the sector basis in a state in which the writes from the plurality of host devices 12 and 13 are mixed.

The host device 31 cannot know whether the host device 12 has issued a flush command. For this reason, a situation may arise in which the host interface 13 needs to process the writes before and after a flush command in the order of, for example, write #1 from the host device 12, write #1 from the host device 31, a flush command from the host device 12, and write #2 from the host device 31.

For the data transferred from the host interface 13, the write buffer control unit 14 holds the logical cluster address, the write buffer address, and the value of the counter 21 in the storage unit 22 as management information for each cluster, as in the first embodiment (S12 and S32).

The write buffer control unit 14 presents, to a write control unit 16, a cluster in which all data are prepared for the write in a NAND flash memory 17 (S13 and S33). The write control unit 16 writes the data in the NAND flash memory 17 at the timing the size of the writable cluster matches the page size.

On the other hand, when, for example, the host device 12 issues a flush command (S14), the host interface 13 supplies the flush command to the write buffer control unit 14 (S15). The write buffer control unit 14 increments the counter 21 in accordance with the flush command and notifies the host interface 13 of the flush command reception. In addition, the write buffer control unit 14 sets all clusters, which have the value of the counter 21 before increment as the management information, to be writable in the NAND flash memory 17 and presents them to the write control unit 16 (S16). Upon receiving a write instruction, the write control unit 16 writes the data in the NAND flash memory 17 even if the size of the write data is smaller than the page size (S17). Even if the size of the data in the write buffer 15 has reached the page size, the write control unit 16 does not execute the write operation without the write instruction.

During the data write in the NAND flash memory 17, the host interface 13 notified of the flush command reception by the write buffer control unit 14 can transfer subsequent data to the write buffer.

For example, when the host device 31 issues a write command (S34), the host interface 13 supplies the write command to the write buffer control unit 14 (S35). The write buffer control unit 14 holds the incremented value of the counter 21 in the storage unit 22 as the management information for the data supplied from the host interface 13 to the write buffer 15. The write buffer control unit 14 presents, to the write control unit 16, a cluster in which the data of all sectors are completed and set to be writable in the NAND flash memory 17 (S36). The write control unit 16 writes the data in the NAND flash memory 17 at the timing the size of the writable cluster matches the page size.

As described above, the data present in the write buffer 15 before the flush command and the data written in the write buffer 15 after the flush command can be identified by the value of the counter 21.

If the arrangement includes no counter 21, write #2 from the host device 31 waits in the host interface 13 while the write buffer control unit 14 is writing all valid data on the write buffer 15 in the NAND flash memory 17 by processing the flush command from the host device 12. Even during this time, writes from both host devices are receivable as long as the resource of the host interface 13 remains. However, write #2 from the host device 31 consumes the resource of the host interface 13. For this reason, both the host devices 12 and 31 may wait until release of the resource of the host interface 13 when the host interface 13 is waiting for completion of the write in the NAND flash memory 17.

According to the second embodiment, in the system in which the host interface 13 can receive commands from the plurality of host devices 12 and 31, the data in the write buffer 15 is managed based on the value of the counter 21 incremented by a flush command, thereby discriminating data before and after the flush command. For this reason, a subsequent command can be received and processed without waiting for completion of flush command processing. This enables to speed up write processing from a plurality of host devices.

### Third Embodiment

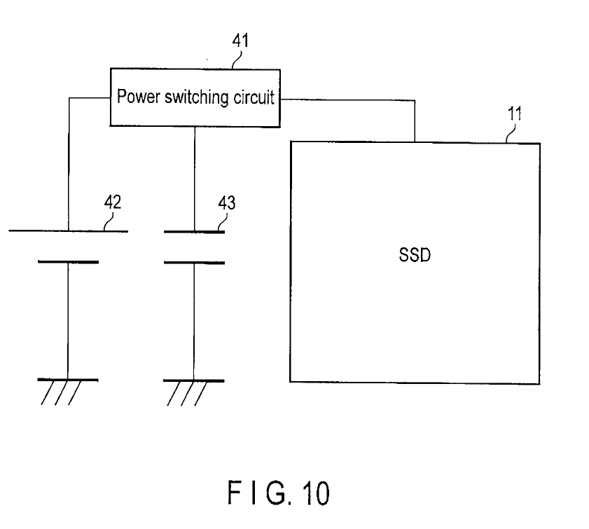

FIG. 10 shows the third embodiment.

The third embodiment features an arrangement including a host interface to which, for example, a single host device is connected, and a mass capacitor.

When the interface specifications allow to receive a new command from the host device only after the flush command processing completion notification has been returned to the host device, as in the first embodiment, the host interface 13 returns the flush processing completion notification to the host device 12 and receives a new write command from the host device 12 at the timing the flush command processing has been received by the write buffer 15.

For this reason, if the system is inappropriately powered off during write in the NAND flash memory 17, the host device 12 may lose the data written in the write buffer 15 before the flush command although the flush command processing completion notification has been received.

To prevent this, in the third embodiment, a mass capacitor is added to the arrangement of the first embodiment to prepare for inappropriate power-off.

That is, as shown in FIG. 10, a DC power supply 42 and a mass capacitor 43 are connected to an SSD 11 via a power switching circuit 41. The DC power supply 42 is formed from a converter that converts battery or AC power into DC power. When power is supplied from the DC power supply 42, the power switching circuit 41 supplies the power to the SSD 11 and charges the capacitor 43 from the DC power supply 42.

On the other hand, when the DC power supply 42 is disconnected, the power switching circuit 41 switches the DC power supply 42 to the capacitor 43 to supply power from the capacitor 43 to the SSD 11. The capacitor 43 has a capacity necessary for a NAND flash memory 17 to complete flush command processing.

According to the third embodiment, the SSD 11 has the mass capacitor 43 as a spare power supply. For this reason, the NAND flash memory 17 can complete write and thus complete flush command processing even if the power supply is disconnected halfway through the write. It is therefore possible to prevent the host device from losing data.

The SSD 11 uses a NAND flash memory as a nonvolatile memory. However, the embodiment is not limited to the NAND flash memory, and any other nonvolatile memory is applicable, as a matter of course.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system comprising:
a nonvolatile memory configured to store data;
a buffer configured to temporarily hold at least one data to be written in the nonvolatile memory;
an interface unit configured to receive a request from a host device; and
a buffer control unit having a counter to be incremented every time a flush request is received to write, in the nonvolatile memory at once, the at least one data held in the buffer, the buffer control unit transferring the at least one data held in the buffer to the nonvolatile memory based on a count value of the counter,
wherein the interface unit is configured to receive a next request when the buffer control unit has received the flush request.

2. The system according to claim 1, wherein the buffer control unit includes a storage unit configured to hold the count value in correspondence with a logical address of the buffer.

3. The system according to claim 1, further comprising a capacitor configured to, when a power supply is disconnected, ensure the power supply until the at least one data held in the buffer is written in the nonvolatile memory based on the flush request.

4. The system according to claim 3, further comprising a switching circuit configured to switch between the power supply and the capacitor.

5. The system according to claim 2, further comprising a write control unit provided between the buffer and the nonvolatile memory, the write control unit writing, in the nonvolatile memory, the data supplied from the buffer.

6. The system according to claim 5, wherein upon receiving the flush request, the buffer control unit supplies, to the write control unit, the data in the buffer associated with the count value before reception of the flush request.

7. The system according to claim 6, wherein upon receiving the flush request, the buffer control unit increments the value of the counter from an initial value.

8. The system according to claim 7, wherein upon receiving the flush request, the buffer control unit adds dummy data to the data in the buffer whose amount is smaller than a cluster size.

9. The system according to claim 8, wherein when the flush request has been received, and the write control unit has completed preparation for data write, the buffer control unit merges the data in the buffer whose amount is smaller than the cluster size with data having the same logical address and supplied to the buffer after the flush request.

10. A memory system comprising:
a nonvolatile memory configured to store data;
a buffer configured to temporarily hold at least one data to be written in the nonvolatile memory;
an interface unit configured to receive a request from a first host device and a second host device; and
a buffer control unit having a counter to be incremented every time a flush request is received to write, in the nonvolatile memory at once, the at least one data supplied from at least one of the first host device and the second host device and held in the buffer, the buffer control unit transferring the at least one data held in the buffer to the nonvolatile memory based on a count value of the counter,
wherein the interface unit is configured to receive a next request when the buffer control unit has received the flush request.

11. The system according to claim 10, wherein the buffer control unit includes a storage unit configured to hold the count value in correspondence with a logical address of the buffer.

12. The system according to claim 10, further comprising a capacitor configured to, when a power supply is disconnected, ensure the power supply until the at least one data held in the buffer is written in the nonvolatile memory based on the flush request.

13. The system according to claim 12, further comprising a switching circuit configured to switch between the power supply and the capacitor.

14. The system according to claim 11, further comprising a write control unit provided between the buffer and the nonvolatile memory, the write control unit writing, in the nonvolatile memory, the data supplied from the buffer.

15. The system according to claim 14, wherein upon receiving the flush request, the buffer control unit supplies, to the write control unit, the data in the buffer associated with the count value before reception of the flush request.

16. The system according to claim 15, wherein upon receiving the flush request, the buffer control unit increments the value of the counter from an initial value.

17. The system according to claim 16, wherein upon receiving the flush request, the buffer control unit adds dummy data to the data in the buffer whose amount is smaller than a cluster size.

18. The system according to claim 17, wherein when the flush request has been received, and the write control unit has completed preparation for data write, the buffer control unit merges the data in the buffer whose amount is smaller than the cluster size with data having the same logical address and supplied to the buffer after the flush request.
